(19) United States
(12) Patent Application Publication
(10) Pub. No.: US 2025/0285548 A1
(43) Pub. Date: Sep. 11, 2025

(54) SYSTEM AND METHOD FOR PERSONALIZED AUTOMATED COACHING POWERED BY GENERATIVE AI

(71) Applicant: NICE LTD., Ra'anana (IL)

(72) Inventors: Shay DINER, Holon (IL); Sourav RATH, Pune (IN); Dhiraj Kumar SINGH, Pune (IN); Lilach ZEMACH, Dunwoody, GA (US); Nilesh SAWANT, Pune (IN); Sanjeev SHARMA, Gurgaon (IN); Shaun MATTHEWS, Salt Lake City, UT (US); Sara OLSON, Buda, TX (US)

(21) Appl. No.: 18/598,504

(22) Filed: Mar. 7, 2024

(51) Int. Cl. G09B 5/06; G06Q 10/0639

(52) U.S. Cl. CPC G09B 5/06; G06Q 10/0639

(57) ABSTRACT

Coaching simulator systems and methods, and non-transitory computer readable media, include receiving an interaction between a customer and an agent; scoring the interaction using an evaluation form; identifying a recurring improvement area for the agent based on the scored interaction and past scored interactions; creating a prompt for a large language model (LLM) by populating a prompt template; providing a framework to invoke the LLM using the created prompt, a model and a plurality of hyperparameters; starting a first coaching simulation scenario by invoking the LLM to present a first question to the agent; receiving a first answer to the first question from the agent; querying the LLM to analyze the first answer to the first question; and querying the LLM to provide real-time feedback and a score for the agent based on the analyzed first answer to the first question.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to methods and systems for simulated coaching of contact center agents, and more particularly to methods and systems that provide simulated coaching where a simulator seamlessly acts as both a customer and a coach.

### BACKGROUND

Today's contact centers face several challenges in training and coaching customer service agents. For example, coaches must skillfully navigate the complexity of human interactions to provide unbiased and effective guidance to customer service representatives during training and performance assessments. Traditional coaching methods may not capture all the nuances of human interaction, limiting the effectiveness of feedback and training.

In addition, developing and updating relevant scenarios that cater to the unique requirements of each contact center includes creating various customer service situations that challenge agents to adapt their approach and manage a diverse range of customer issues, especially those scenarios in which agents frequently fail.

Ensuring that new agents receive adequate and consistent training to manage real customer interactions effectively is not easy. In many contact centers, the quality of training can vary, making it difficult for new agents to develop the skills required to provide excellent customer service.

Sustained skill enhancement includes keeping experienced agents engaged and motivated to continue practicing and refining their skills. As customer service representatives gain experience, it is crucial to provide ongoing training and development opportunities to maintain their performance and address any skill gaps.

Providing accurate, unbiased, and actionable feedback to agents to help them identify areas of improvement and track their progress is important. Traditional coaching methods might not offer personalized feedback, which may result in agents not being aware of their shortcomings or not receiving guidance on how to improve.

Accommodating an increasing number of customer service representatives and adapting to the organization's changing needs is also important. As contact centers grow or their objectives shift, it is important to ensure that training and coaching resources can scale up accordingly.

Lastly, coaching should be easily accessible to all customer service representatives, regardless of their location and working hours. Remote work and global operations require flexible training solutions that cater to diverse agent schedules and locations.

Accordingly, there is a need for a solution that improves training and coaching in contact centers that addresses the above issues, which encompass the complexity of human interactions, dynamic scenario customization and personalization, comprehensive onboarding experience, sustained skill enhancement, personalized and constructive feedback, adaptable scalability, and seamless accessibility.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of an embodiment of a coaching simulator system according to embodiments of the present disclosure.

FIG. 2A is a method for identifying improvement scenarios according to embodiments of the present disclosure.

FIG. 2B is a method for coaching simulation according to embodiments of the present disclosure.

FIG. 3 is a code snippet used to generate a prompt according to embodiments of the present disclosure.

FIG. 4 is a code snippet used to create a chat conversation chain according to embodiments of the present disclosure.

FIGS. 5A-5C illustrates exemplary interactions between an agent and a coaching simulator system according to embodiments of the present disclosure.

FIG. 6 is an exemplary screenshot illustrating how a coaching simulator system reminds an agent to focus on a question according to embodiments of the present disclosure.

FIG. 7 is a screenshot of an exemplary summary report according to embodiments of the present disclosure.

FIG. 8 illustrates exemplary screenshots of interactions between a coaching simulator system and an agent according to embodiments of the present disclosure.

FIG. 9 is a flowchart of a method according to embodiments of the present disclosure.

FIG. 10A illustrates an example of a prompt template according to embodiments of the present disclosure.

FIG. 10B illustrates an exemplary definition of an evaluation form according to embodiments of the present disclosure.

FIG. 10C illustrates exemplary evaluation questions according to embodiments of the present disclosure.

FIG. 10D provides an exemplary simulation objective and an exemplary simulation example according to embodiments of the present disclosure.

FIG. 11 is a block diagram of a computer system suitable for implementing one or more components in FIG. 1 according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The present systems and methods relate to a generative artificial intelligence (AI) driven coaching conversation simulator that enhances agent performance through customer training, allows agents to practice handling real-life customer scenarios, provides real-time feedback and personalized guidance, uses AI-driven technology for realistic interactions, and provides a risk-free environment to develop effective communication skills.

In an exemplary embodiment, a coaching simulator system receives an interaction between a customer and an agent, scores the interaction using an evaluation form, identifies a recurring improvement area for the agent based on the scored interaction and past scored interactions, creates a prompt for a large language model (LLM) by populating a prompt template, provides a framework to invoke the LLM using the created prompt and a plurality of hyperparameters, starts a first coaching simulation scenario by invoking the LLM to present a first question to the agent, receives a first answer to the first question from the agent, queries the LLM to analyze the first answer to the first question, and queries the LLM to provide real-time feedback and a score for the agent based on the analyzed first answer to the first question.

The present AI-driven virtual coaching methods are based on quality management (QM) principles and revolutionize agent performance enhancement. In several embodiments, the methods utilize QM evaluation forms and identify patterns of failure where agents are consistently lagging, based on their evaluation scores. There is direct communication to coaches about problematic topics discovered, allowing the coach to choose whether to lead a manual process of a coaching session or to let the system contextualize a simulated coaching session based on the problematic topics.

In one or more embodiments, the coaching simulator system uses AI to analyze agents' performance patterns, identifying areas where the agent excels and where the agent needs improvement. This deep pattern analysis allows the coaching simulator system to provide targeted feedback, helping agents to focus on specific skill areas that need development. Existing solutions may provide performance analytics, but the coaching simulator system's AI-driven pattern analysis offers more in-depth insights to support individual growth.

In various embodiments, the coaching simulator system is a versatile coaching simulator that provides immersive and engaging coaching experiences by assuming the roles of both coach and customer, setting it apart from conventional methods. By acting as a coach and as a customer in role-playing scenarios, the coaching simulator uses AI algorithms to develop and update realistic scenarios. It creates diverse customer situations that challenge agents, helping them to improve their ability to adapt to different customer issues, including those scenarios in which they frequently struggle.

In some embodiments, by incorporating advance pattern analysis capabilities as well as role-play scenarios that function as both coach and customer, the present systems and methods offer a unique and engaging training experience for customer service agents.

In some embodiments, there is simulation of diverse real-life customer scenarios with real-time feedback for targeted skill development and confidence building, offering several scenarios for each topic with a scoring system for each scenario. This level of dynamic scenario customization is not available in existing solutions, which typically only provide performance monitoring or evaluation, but do not offer tailored, dynamic scenarios for training purposes. Upon successful completion of the training program, agents may receive a certificate recognizing their expertise in handling customer interactions and showcasing their commitment to delivering exceptional customer experiences.

By utilizing generative AI in the coaching simulator, the coaching simulator system tackles the challenges faced by contact centers in terms of agent training and coaching. It enables agents to practice their skills in a risk-free environment, gain experience managing various customer scenarios, and receive personalized feedback to improve their performance. As a result, the coaching simulator system leads to better performance, increased organizational efficiency, and enhanced customer satisfaction. The AI-driven coaching system addresses the challenges faced by contact centers effectively.

In one embodiment, the coaching simulator system identifies problematic areas in the agents' evaluation forms. The generative AI used in the coaching simulator system can replicate complex human interactions and provide unbiased guidance. By eliminating the potential for human bias, the AI ensures the coaching is fair, accurate, and effective, leading to better-informed decisions regarding agent training and development. Existing solutions may use AI for analytics or routing, but not for simulating complex human interactions in a coaching context.

In several embodiments, the coaching simulator system provides new agents with consistent and targeted training experiences that equip them with the necessary skills to manage real customer interactions effectively. This uniform onboarding process helps the agent(s) further develop the skills required to provide excellent customer service.

The coaching simulator allows experienced agents to engage in ongoing training and development by participating in realistic simulated scenarios. This ensures that they continue practicing and refining their skills, leading to sustained performance improvement, and addressing any skill gaps that may arise.

In one or more embodiments, the coaching simulator system provides real-time, accurate, and unbiased feedback tailored to each agent's performance. This helps agents identify areas of improvement, track their progress, and receive actionable guidance on how to enhance their customer service skills. Existing solutions may provide some form of performance feedback, but they are generally not personalized or provided in real-time.

In certain embodiments, the coaching simulator system can easily accommodate an increasing number of customer service representatives, making it highly adaptable to an organization's changing needs. As contact centers grow or their objectives evolve, the coaching simulator system can scale accordingly to provide continuous support and training resources.

Additionally, in many embodiments, the coaching simulator system can be accessed remotely, ensuring that all customer service representatives can benefit from coaching, regardless of their location or working hours. This enables a flexible training environment for globally distributed or remote teams, providing equal opportunities for skill development. Existing solutions may offer some scalability or accessibility potential, but the coaching simulator system's AI-driven approach enhances its adaptability and accessibility potential.

Advantageously, the coaching simulator system enhances agent performance through virtual training by utilizing advanced technology to replicate customer interactions and allowing agents to practice various skills, such as problem-solving, empathy, and active listening. Moreover, agents can practice handling real-life customer scenarios because the coaching simulator system simulates diverse customer situations and challenges for personalized targeted coaching and exposes agents to various customer personalities, expectations, and issues, and enables agents to develop a wide range of skills to handle different customer needs effectively. Furthermore, agents receive real-time feedback and personalized guidance. AI-driven feedback provides instant feedback and fosters a growth mindset and encourages agents to learn from mistakes. Customized learning experiences are tailored to individual agent strengths and weaknesses. AI-driven technology provides realistic interactions where advanced algorithms create life-like customer interactions and challenges and provide continuously updated scenarios based on industry trends and user feedback. In addition, the coaching simulator system provides a risk-free environment to develop effective communication skills where agents can practice without fear of negatively impacting real customers or business reputation. A safe space to experiment with different approaches and learning from errors is provided. Agents can build confidence and competence in handling challenging customer situations before engaging in real-life interactions, i.e., without creating problems with an actual customer.

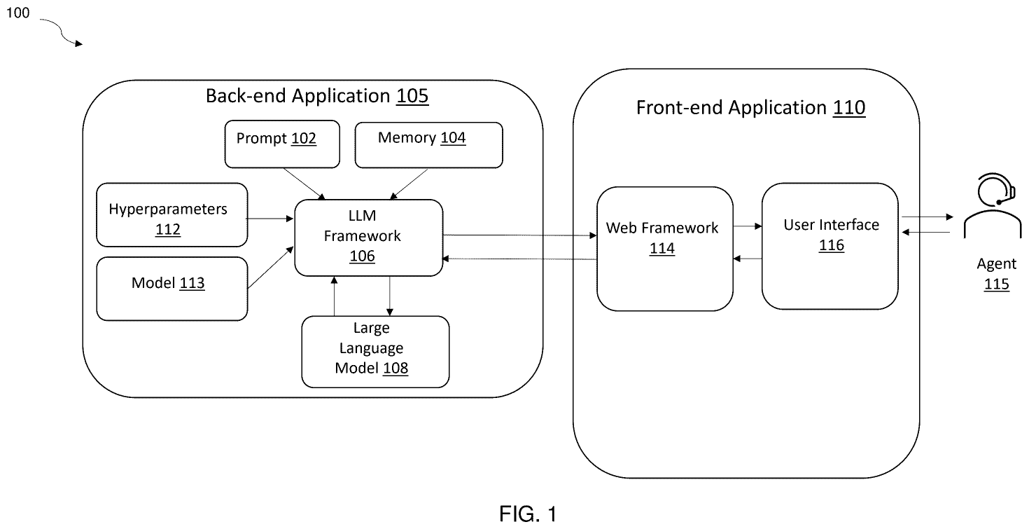

FIG. 1 illustrates an exemplary coaching simulator system 100 including a back-end LLM application 105 and a chat-based front-end web application 110. As shown, the back-end application 105, front-end application 110, and the agent 115 interact. A system flow for a method according to the present disclosure is also illustrated.

The role of the back-end application 105 is to set up the context of the coaching simulation using appropriate prompts, set up a chain involving a LLM 108 using hyperparameters, invoke the LLM 108 to get responses, and maintain the conversational memory of the simulation. This back-end application 105, with a proper prompt 102, plays the dual role of a customer and a coach. Based on the evaluation form provided in the prompt 102, the back-end application 105 also provides feedback and a score for agent responses.

The LLM framework 106 forms the backbone of the back-end application 105. In an exemplary embodiment, the LLM framework 106 is the LangChain framework, which provides application program interfaces (APIs) and boilerplate code to invoke the LLM 108 based on provided prompts 102, while maintaining a conversational chat memory 104.

Memory 104 represents the chat conversational memory 104 of the simulation and holds the record of the overall conversation between the coaching simulator system 100 and the agent 115. There are different kinds of memory provided by the LangChain framework. In an exemplary embodiment, ConversationBufferMemory, provided by the LangChain framework, is used to keep the simulation context and chat history. For longer conversations, ConversationSummaryBufferMemory, also provided by the LangChain framework, could also be used, so that if the earlier chat messages exceed the token limit, they could be summarized, and more recent chat messages could be buffered.

A model 113 and its associated hyperparameters 112 are provided to LLM framework 106. The model 113 is invoked by the LLM framework 106. The hyperparameters 112 include a temperature hyperparameter and a top_p hyperparameter. In an exemplary embodiment, the model 113 invoked by the LLM framework 106 includes a generative pre-trained transformer (GPT), such as the GPT-4 model from Microsoft Azure OpenAI Service. The LLM 108 is invoked by the back-end application 105 based on the model 113. The temperature hyperparameter controls the randomness of the response of the LLM 108. Its valid value can range from 0 to 1, where a value closer to 0 means lower randomness and a value closer to 1 means higher randomness. The top_p hyperparameter represents the smallest set of tokens whose cumulative probability does not exceed top_p. Top_p ranges from 0 to 1 by default, and a lower top_p means the model samples form a narrower selection of words. For instance, if top_p is set at 0.1, only tokens including the top 10% probability are considered.

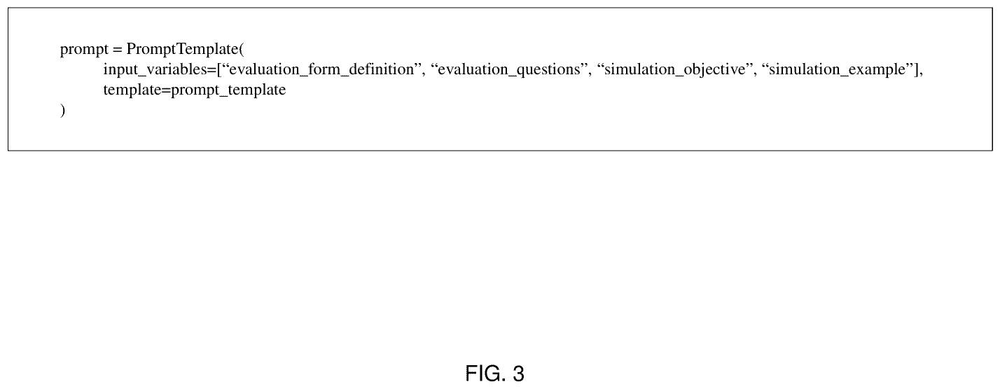

The prompt 102 is also provided to LLM framework 106. The prompt 102 invokes the LLM 108, and is used to set up the context of the coaching simulation with the relevant coaching scenarios and evaluation form questions. The prompt 102 is created by populating a prompt template with a definition of an evaluation form, evaluation questions, a simulation objective, and a simulation example. Referring to FIG. 3, shown is a code snippet to generate the final prompt 102 to set up the coaching simulator context by replacing the placeholders in the prompt template with a definition of an evaluation form, evaluation questions, a simulation objective, and simulation examples.

Front-end application 110 represents the chat-based front-end application of the coaching simulator system 100. The front-end application 110 includes the user interface 116 of the virtual coaching room to display the different chat messages of the coaching simulator as provided by back-end application 105, and captures the agent responses. As received from the back-end application 105, the user interface 116 displays the coaching simulator's simulation context, simulation scenario, feedback, and score of the agent's response for the given scenario.

The web framework 114 of the front-end application 110 represents the web component of the coaching simulator system 100 that integrates with the LLM framework 106 seamlessly. In an exemplary embodiment, the Streamlit library is used for the user interface 116, although the web application can be developed in any other suitable platform.

Agent 115 represents the contact center agent that interacts with the coaching simulator system 100 in the virtual coaching room. Agent 115 begins the coaching simulation and provides responses to the simulation scenarios and receives feedback, scores, and a final summary report from the coaching simulator system 100.

In one or more embodiments, a question is first presented to the agent 115 on user interface 116 per the simulation context. In this moment, the coaching simulator system 100 acts as a customer and interacts with the agent 115. The agent 115 responds to the question via the user interface 116. The coaching simulator system 100 then provides feedback and a score for the agent's response on the user interface 116. In this moment, the coaching simulator system 100 acts as a coach and interacts with the agent.

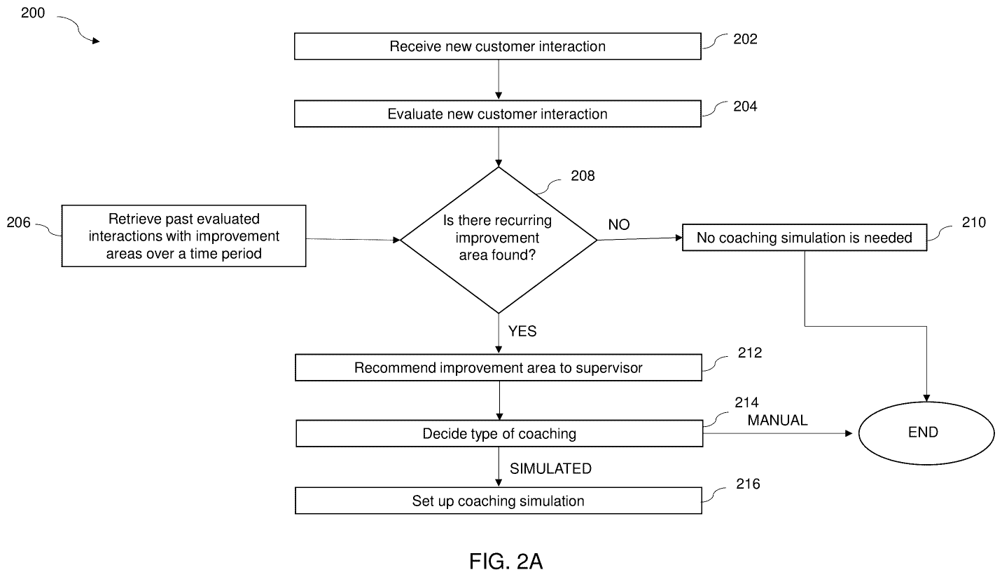

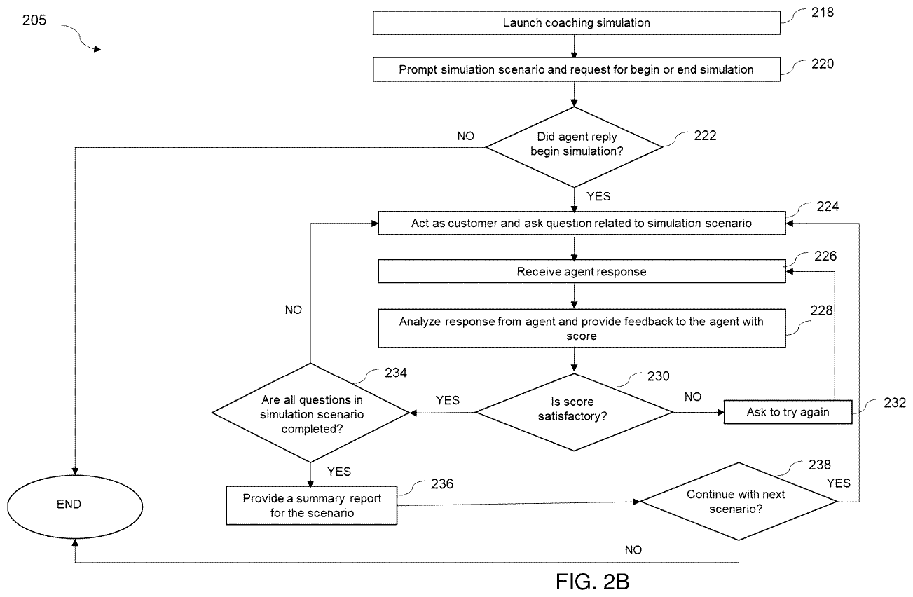

Referring now to FIG. 2A, shown is a method 200 that is used to identify improvement scenarios for contact center agent 115. These improvement scenarios are used to set up the coaching simulation context for the agent 115.

In method 200, at step 202, a contact center receives a new customer interaction that the agent 115 had with a customer. Such interactions can take place through various channels such as a voice call, chat, email, or other digital channels.

At step 204, the contact center, via a contact center quality evaluator or an automated process, evaluates the quality of the new customer interaction using an evaluation form. A quality or evaluation form is a structured document used to assess or measure the performance of an agent. This form typically covers various aspects of an agent's job, including their ability to manage customer interactions, adhere to company policies and procedures, communication skills, problem-solving abilities, and overall productivity. Contact center supervisors or quality assurance teams use evaluation forms to provide agents with constructive feedback, identify strengths and areas for improvement, and monitor performance trends over time. The results of these evaluations often play a crucial role in agent coaching, training, and performance management, ultimately contributing to the contact center's overall effectiveness and customer satisfaction.

At step 206, the coaching simulation system 100 retrieves past evaluated interactions of the agent 115 including improvement areas over a certain time period. For the agent 115, all past evaluated interactions from a specified period are maintained, along with improvement areas of the agent 115 based on the evaluation forms. These improvement areas are used for pattern analysis to identify one or more targeted improvement areas, e.g., where the agent most needs improvement, where the agent might benefit the most from training or coaching, or both.

At step 208, the coaching simulation system 100 compares the evaluation results of the new customer interaction with the past evaluated results to determine whether there is a recurring improvement area for the agent 115. It is important to identify a pattern of recurring improvement areas for the agent 115 and to rule out any one time or less frequently identified improvement areas. Such recurring improvement areas identified are used to set up the context of the coaching simulator system 100. In various embodiments, the pattern analysis takes place by searching for all valid evaluated interactions of the agent 115 with a lower evaluation score, filtering the agent interaction evaluation scenarios with scores below a threshold of k %, and extracting only the top n most frequently identified evaluation improvement scenarios.

If there is no recurring improvement area found for the agent 115, then the coaching simulator system 100 determines that no coaching simulation is needed (or would not be particularly useful) at step 210.

If a recurring improvement area is identified, then the coaching simulator system 100 recommends an improvement area to the supervisor of the agent 115 in step 212. Such recommendation can be in the form of coaching opportunities, plans, or materials for the agent 115.

At step 214, the supervisor decides the type of coaching to be imparted to the agent 115 depending on the recommended improvement area(s). The coaching type can be a manual coaching session by a coach or a supervisor or could be personalized coaching using a simulator using context based on the evaluation form and the recurring improvement area. If the supervisor opts for manual coaching by creating a coaching session, then no further action in terms of the coaching simulator system 100 is needed.

On the other hand, if the supervisor opts for personalized coaching simulation for the agent 115, then the coaching simulator context is set up based on the evaluation form and recurring improvement area using the back-end application 105. At this stage, a prompt 102 is created when the placeholders of the prompt template are populated by the corresponding evaluation form questions and simulation objective. For example, the improvement area can be identified as “providing the correct solution” and/or “empathizing with the customer.” A supervisor is always able to supplement the system and methods disclosed herein by using additional manual coaching.

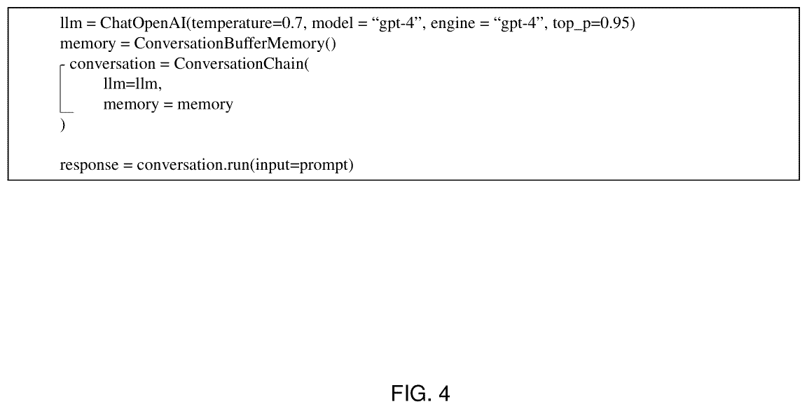

A chat conversation chain is also created as shown in FIG. 4. As shown in the code snippet in FIG. 4, the model 113 and its hyperparameters temperature and top_p are used to set up the LLM 108 that will be queried during the coaching simulation.

In addition, the memory 104 of the chat conversation is set up at this stage. Using the generated prompt 102, the back-end application 105 sets up the context and conversational memory 104 of the coaching simulator for the agent 115. In an exemplary embodiment, the LLM 108 is deployed and accessed through Microsoft Azure OpenAI Service and the back-end application 105 is based on the LangChain framework.

Referring now to FIG. 2B, shown is a method 205 for coaching simulation. At step 218, once the coaching simulation system 100 is set up with the required context for the agent 115, the agent launches the coaching simulator front-end application 110.

At step 220, the coaching simulator system 100, based on the output of the LLM 108, describes a coaching simulation scenario to the agent 115 and requests the agent 115 to either begin the simulation or end the simulation.

At step 222, the agent 115 decides if he/she wants to begin the simulation. If the agent 115 decides to end the simulation, then no further actions need to be taken and the coaching simulator system 100 exits. If the agent 115 decides to begin the simulation, then the method 205 proceeds to step 224.

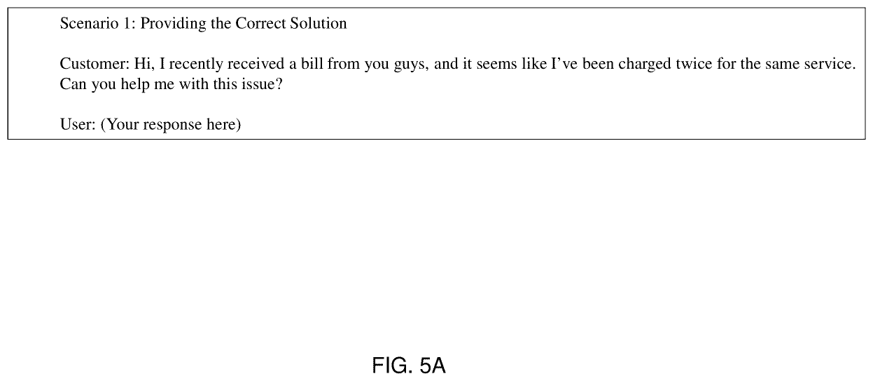

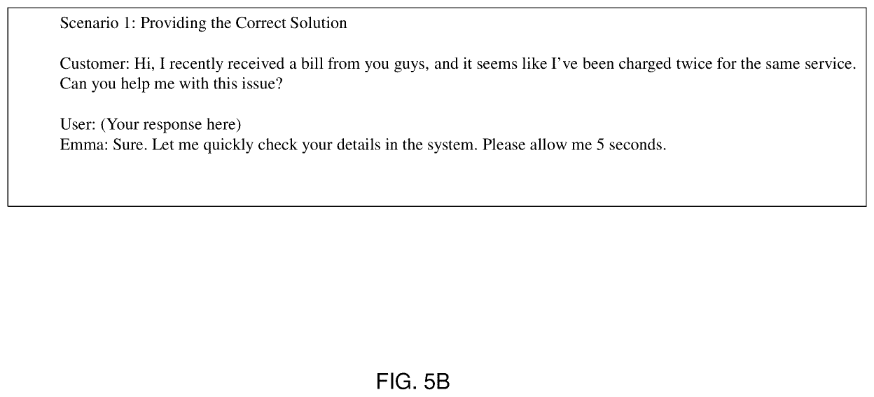

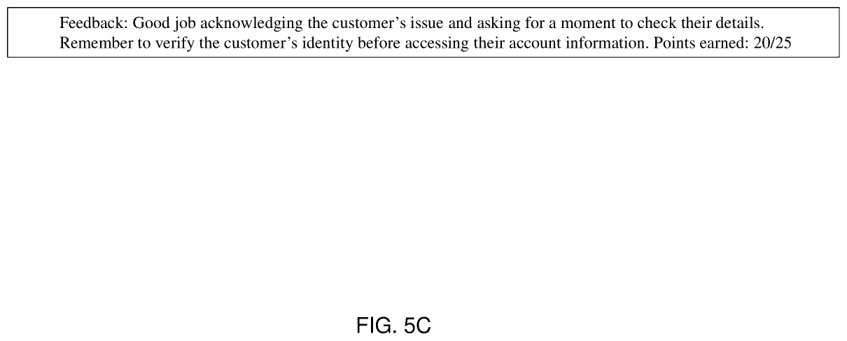

At step 224, the coaching simulator system 100 acts as a customer and based on the coaching simulation scenario, asks a question as shown in FIG. 5A.

At step 226, the agent 115 responds to the question as shown in FIG. 5B.

At step 228, the coaching simulator system 100 acts as a coach and, with the help of the LLM 108, analyzes the response provided by the agent 115 per the evaluation form and evaluation questions from the prompt 102. After analyzing the response, the coaching simulator system 100 provides feedback and a score for that response, as shown in FIG. 5C.

At step 230, the coaching simulator system 100 determines if the score for the agent response is satisfactory or it is less than a predefined minimum satisfactory score. If it less than the predefined minimum satisfactory score, at step 232, the coaching simulator system 100 asks the agent 115 to try answering the same question again, and the method 205 goes back to step 226.

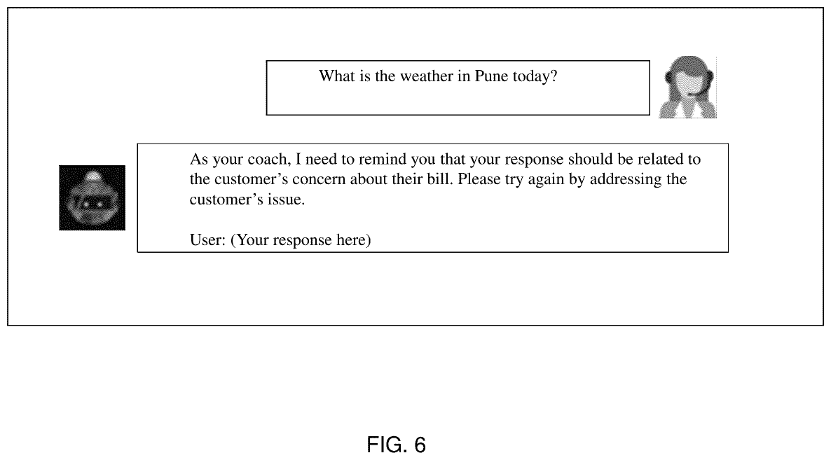

If the agent's response is out of context as per the coaching simulation scenario, then the coaching simulator system 100 informs the agent 115 that his/her response is not related to the scenario's question and also requests the agent 115 to try again at step 232. FIG. 6 provides an exemplary screenshot of the user interface 116 when the coaching simulator system 100 reminds the agent 115 to focus on the question.

If the score is greater than the threshold, at step 234, the coaching simulator system 100 checks if all the questions in the coaching simulation scenario are completed. If there are more questions remaining, then method 205 goes back to step 224 and asks the next question. If all the questions are completed, then the coaching simulator system 100 proceeds to provide a summary report of the coaching simulation scenario at step 236.

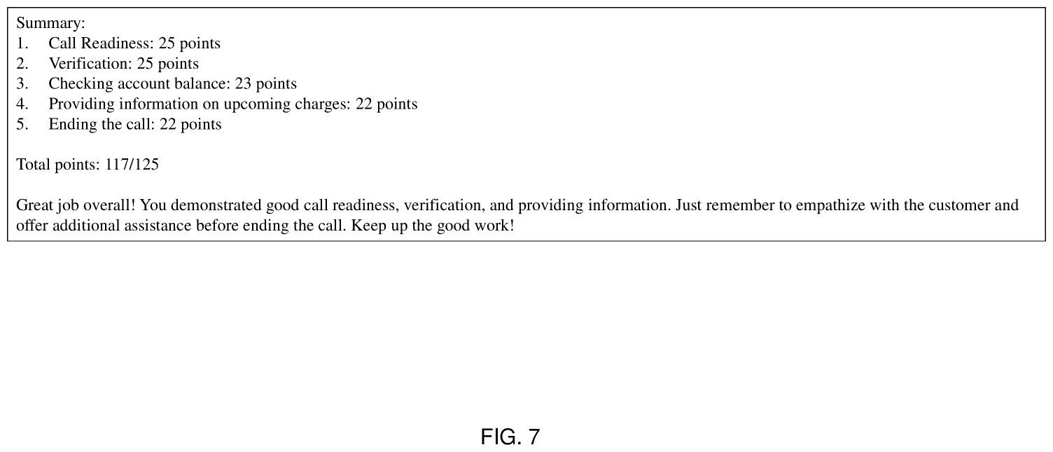

At step 236, the coaching simulator system 100 provides a summary report of the coaching simulation scenario based on its overall assessment of the simulated interaction with the agent 115. As in the case of scoring of agent responses, the coaching simulator system 100 acts as a coach and with the help of the LLM 108, analyzes the overall interaction with the agent 115 as per the evaluation form and evaluation questions from the prompt 102. FIG. 7 provides a screenshot of an exemplary summary report.

At step 238, the coaching simulator system 100 asks the agent 115 whether the agent 115 wants to end the simulation or continue to the next simulation scenario. If the agent 115 continues with the next simulation scenario, questions related to the next coaching simulation scenario are asked, and the method 205 goes back to step 224.

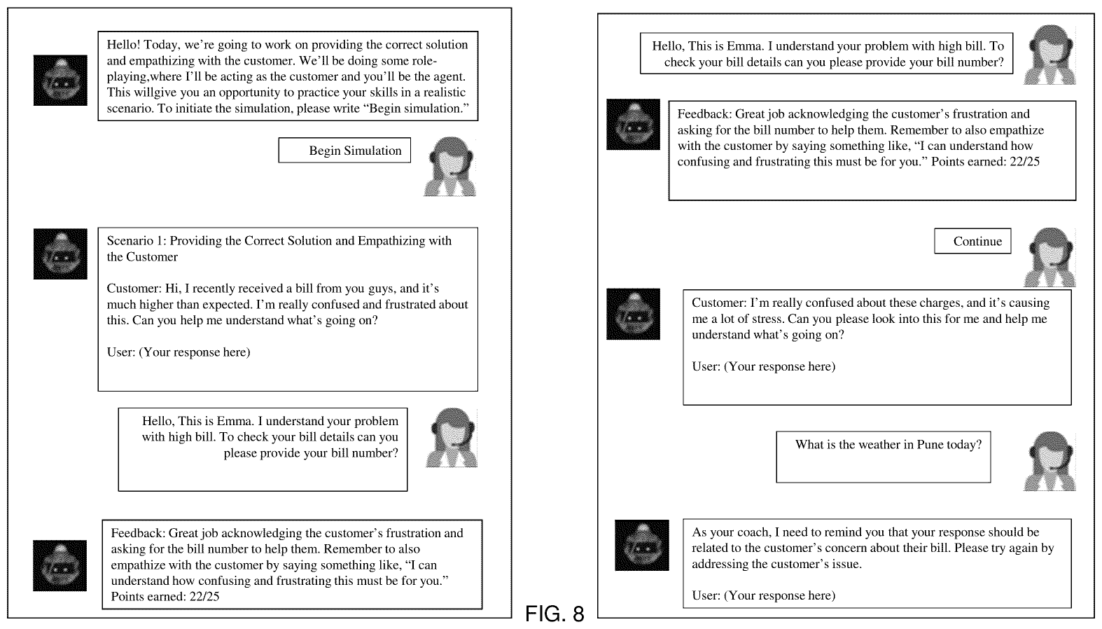

FIG. 8 illustrates exemplary screenshots of interactions between the coaching simulator system 100 and the agent 115. On the left side, the coaching simulator system 100 launches a coaching simulation scenario and the agent 115 begins the simulation. Next, the coaching simulator system 100 asks a question related to the scenario, the agent 115 responds to the question, and the coaching simulator system 100 provides feedback, a suggestion, and a score. On the right side, the agent's response to the question is not in context, and the coaching simulator system 100 informs the agent that the response is not related to the scenario's question and asks the agent to try again.

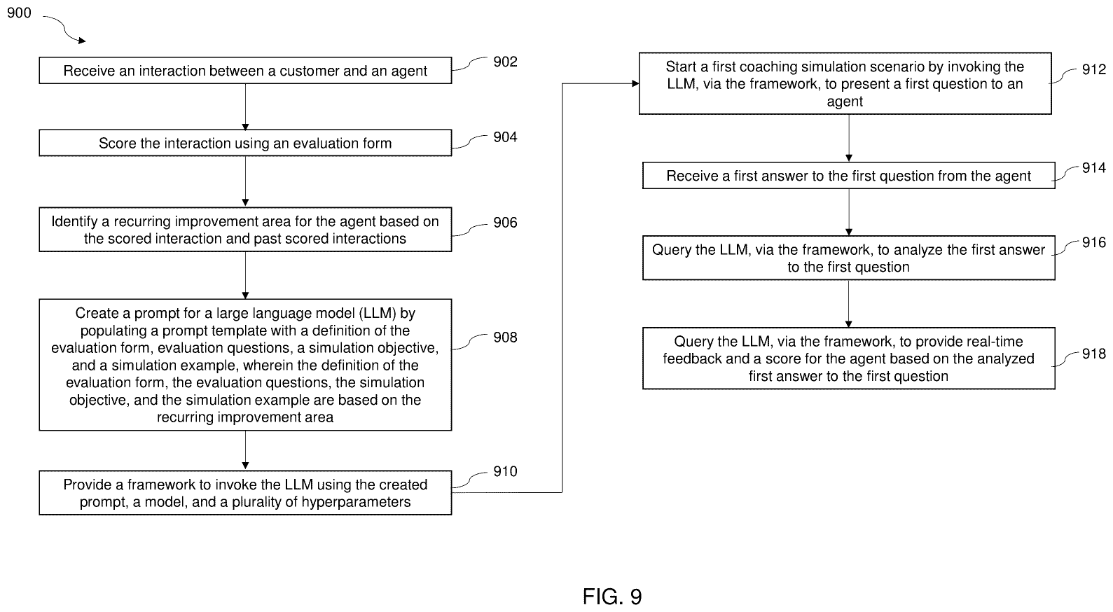

Turning now to FIG. 9, shown is an exemplary method 900 according to the present disclosure. At step 902, a contact center receives an interaction between a customer and an agent 115. At step 904, the contact center scores the interaction using an evaluation form.

At step 906, the coaching simulator system 100 identifies a recurring improvement area for the agent 115 based on the scored interaction and past scored interactions. In various embodiments, the contact center identifies a recurring improvement area for the agent 115 by selecting past scored interactions with a score lower than a threshold score, and identifying a most frequent scenario in the selected past scored interactions.

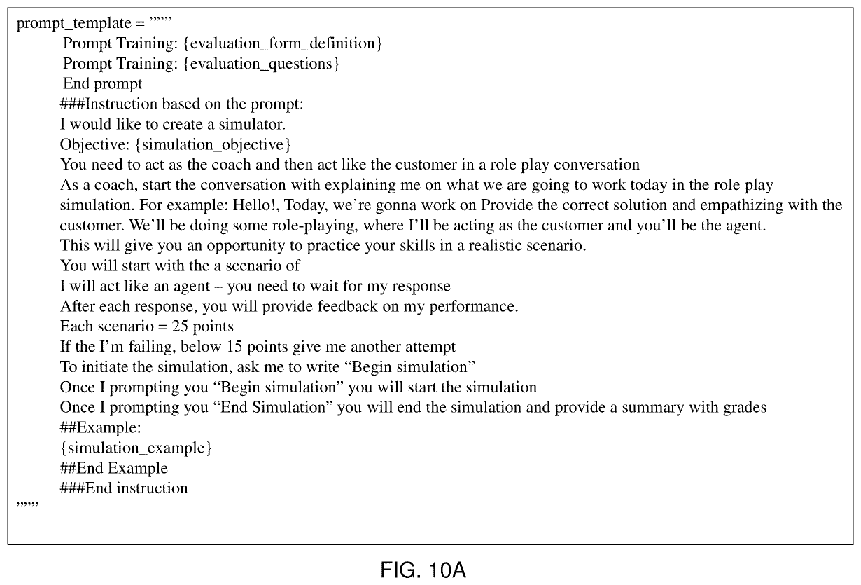

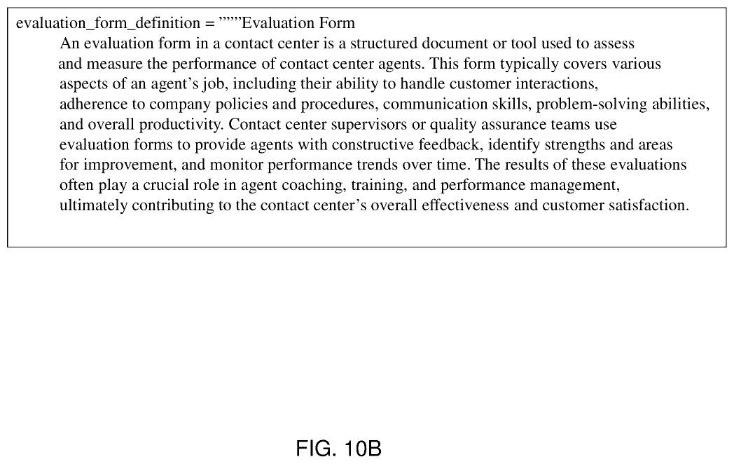

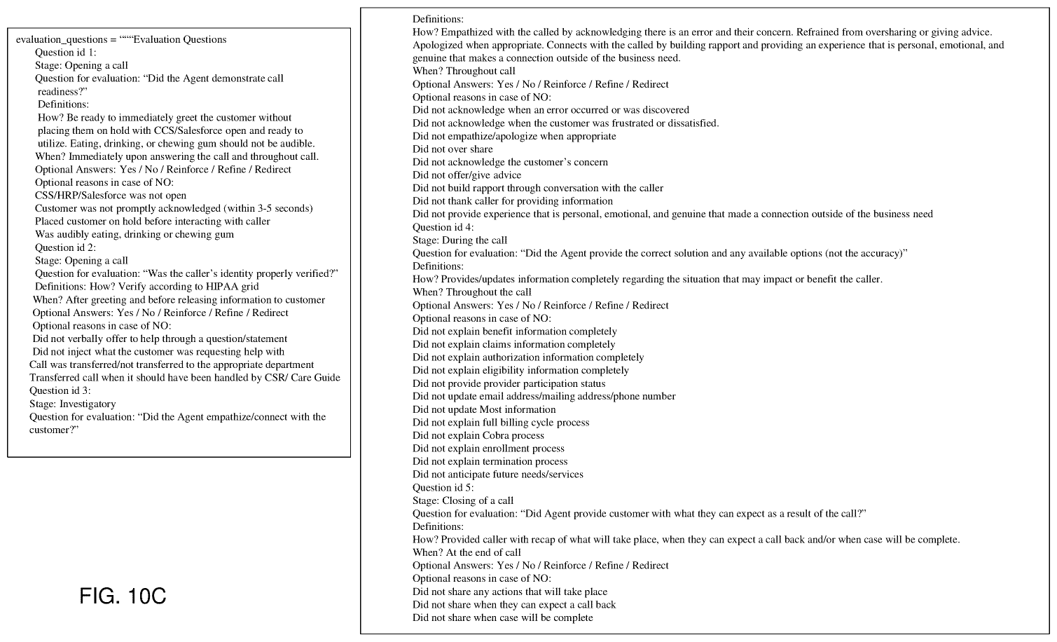

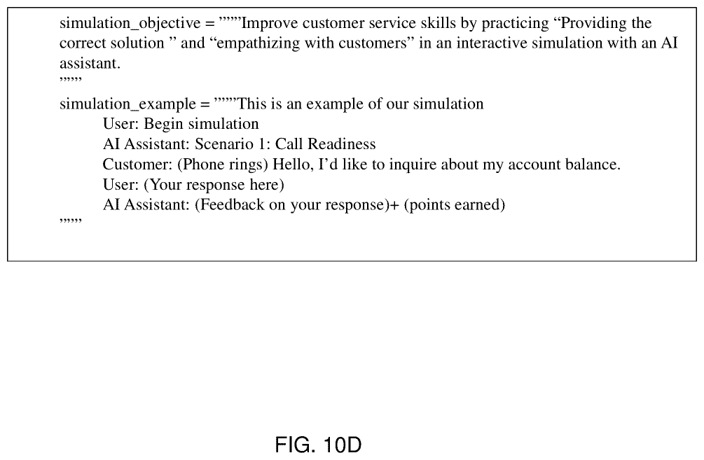

At step 908, the coaching simulator system 100 creates a prompt 102 for a LLM 108 by populating a prompt template with a definition of the evaluation form, evaluation questions, a simulation objective, and a simulation example. In an exemplary embodiment, the LLM 108 includes a generative trained transformer (GPT). The definition of the evaluation form, the evaluation questions, the simulation objective, and the simulation example are based on the recurring improvement area. FIG. 10A provides an example of a prompt template.

FIG. 10B provides an exemplary definition of an evaluation form, which defines what an evaluation form in a contact center means in the context of quality assessment. FIG. 10C provides exemplary evaluation questions. Both the definition of the evaluation form and the evaluation questions guide the LLM 108 to evaluate the agent's response by providing feedback and a score. The definition of the evaluation form and the evaluation questions are based on the analyzed pattern of the agent's interactions for improvement scenarios.

FIG. 10D provides an example of a simulation objective and a simulation example. The simulation objective also guides the LLM 108 in evaluating the agent's response. The simulation objective is based on the analyzed pattern of the agent's interactions for improvement scenarios. The simulation example is used to train the AI model using the technique of few-shot prompting, which uses a few explicit examples (or shots) to guide the coaching simulator system 100 to respond in a specific way.

At step 910, the contact center provides a framework 106 to invoke the LLM 108 using the created prompt 102, the model 113, and a plurality of hyperparameters 112. In some embodiments, the hyperparameters 112 include a temperature hyperparameter and a top_p hyperparameter. In one or more embodiments providing a framework to invoke the LLM 108 includes maintaining a conversational memory 104 of the first coaching simulation scenario.

At step 912, the back-end application 105 starts a first coaching simulation scenario by invoking the LLM 108, via the framework 106, to present a first question to an agent 115.

At step 914, the back-end application 105 receives a first answer to the first question from the agent 115.

At step 916, the back-end application 105 queries the LLM 108, via the framework 106, to analyze the first answer to the first question.

At step 918, the back-end application 105 queries the LLM 108, via the framework 106, to provide real-time feedback and a score for the agent 115 based on the analyzed first answer to the first question.

In one or more embodiments, the method 900 also includes determining that the score for the agent 115 is below a predefined minimum score, querying the LLM 108, by the framework 106, to ask the agent 115 to answer the first question again, receiving a second answer to the first question from the agent 115, querying the LLM 108, by the framework 106, to analyze the second answer to the first question, and querying the LLM 108, by the framework 106, to provide real-time feedback and a score for the agent 115 based on the analyzed second answer to the first question.

In several embodiments, the method 900 also includes determining that the score for the agent 115 exceeds a predefined minimum score, determining that there is a second question in the first coaching simulation scenario, querying the LLM 108, by the framework 106, to present the second question to the agent 115, receiving a first answer to the second question from the agent 115, querying the LLM 108, by the framework 106, to analyze the first answer to the second question, and querying the LLM 108, by the framework 106, to provide real-time feedback and a score for the agent 115 based on the analyzed first answer to the second question.

In certain embodiments, the method 900 also includes determining that the score for the agent 115 exceeds a predefined minimum score, determining that there are no more questions in the first coaching simulation scenario, querying the LLM 108, by the framework 106, to provide a summary report, and confirming that the agent 115 wishes to continue to a second coaching simulation scenario.

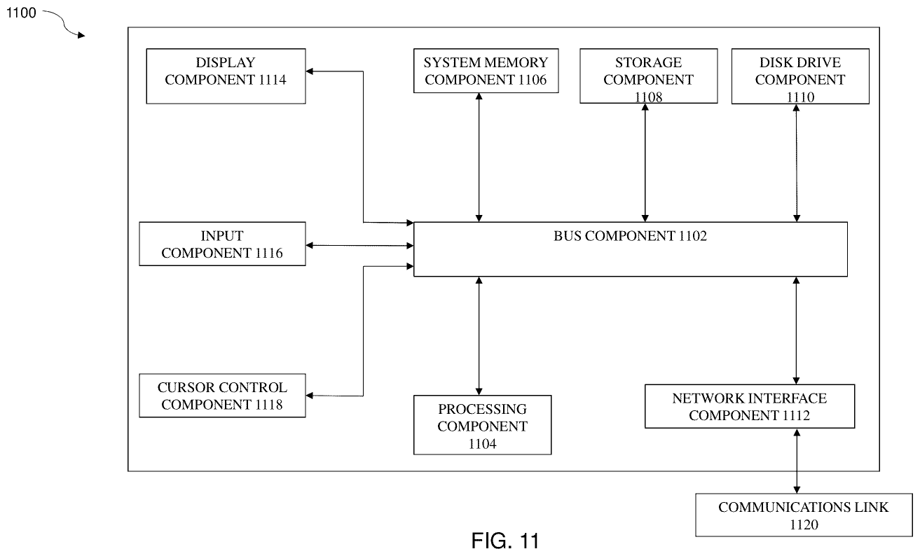

Referring now to FIG. 11, illustrated is a block diagram of a system 1100 suitable for implementing embodiments of the present disclosure. System 1100, such as part of a computer and/or a network server, includes a bus 1102 or other communication mechanism for communicating information, which interconnects subsystems and components, including one or more of a processing component 1104 (e.g., processor, micro-controller, digital signal processor (DSP), etc.), a system memory component 1106 (e.g., RAM), a static storage component 1108 (e.g., ROM), a network interface component 1112, a display component 1114 (or alternatively, an interface to an external display), an input component 1116 (e.g., keypad or keyboard), and a cursor control component 1118 (e.g., a mouse pad).

In accordance with embodiments of the present disclosure, system 1100 performs specific operations by processor 1104 executing one or more sequences of one or more instructions contained in system memory component 1106. Such instructions may be read into system memory component 1106 from another computer readable medium, such as static storage component 1108. These may include instructions to receive an interaction between a customer and an agent; score the interaction using an evaluation form; identify a recurring improvement area for the agent based on the scored interaction and past scored interactions; create a prompt for a large language model (LLM) by populating a prompt template with a definition of the evaluation form, evaluation questions, a simulation objective, and a simulation example, wherein the definition of the evaluation form, the evaluation questions, the simulation objective and the simulation example are based on the recurring improvement area; provide a framework to invoke the LLM using the created prompt, a model, and a plurality of hyperparameters; start a first coaching simulation scenario by invoking the LLM, via the framework, to present a first question to the agent; receive a first answer to the first question from the agent; query the LLM, via the framework, to analyze the first answer to the first question; and query the LLM, via the framework, to provide real-time feedback and a score for the agent based on the analyzed first answer to the first question. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 1104 for execution. Such a medium may take many forms, including but not limited to, non-volatile media, volatile media, and transmission media. In various implementations, volatile media includes dynamic memory, such as system memory component 1106, and transmission media includes coaxial cables, copper wire, and fiber optics, including wires that comprise bus 1102. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 1100. In various other embodiments, a plurality of systems 1100 coupled by communication link 1120 (e.g., LAN, WLAN, PTSN, or various other wired or wireless networks) may perform instruction sequences to practice the disclosure in coordination with one another. Computer system 1100 may transmit and receive messages, data, information and instructions, including one or more programs (i.e., application code) through communication link 1120 and communication interface 1112. Received program code may be executed by processor 1104 as received and/or stored in disk drive component 1110 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. A coaching simulator system comprising:
a processor and a computer readable medium operably coupled thereto, the computer readable medium comprising a plurality of instructions stored in association therewith that are accessible to, and executable by, the processor, to perform operations which comprise:
receiving an interaction between a customer and an agent;
scoring the interaction using an evaluation form;
identifying a recurring improvement area for the agent based on the scored interaction and past scored interactions;
creating a prompt for a large language model (LLM) by populating a prompt template with a definition of the evaluation form, evaluation questions, a simulation objective, and a simulation example, wherein the definition of the evaluation form, the evaluation questions, the simulation objective and the simulation example are based on the recurring improvement area;
providing a framework to invoke the LLM using the created prompt, a model, and a plurality of hyperparameters;
starting a first coaching simulation scenario by invoking the LLM, via the framework, to present a first question to the agent;
receiving a first answer to the first question from the agent;
querying the LLM, via the framework, to analyze the first answer to the first question; and
querying the LLM, via the framework, to provide real-time feedback and a score for the agent based on the analyzed first answer to the first question.

2. The coaching simulator system of claim 1, wherein identifying a recurring improvement area for the agent comprises:
selecting past scored interactions with a score lower than a threshold score; and
identifying a most frequent scenario in the selected past scored interactions.

3. The coaching simulator system of claim 1, wherein the hyperparameters comprise a temperature hyperparameter and a top_p hyperparameter.

4. The coaching simulator system of claim 1, wherein providing a framework to invoke the LLM comprises maintaining a conversational memory of the first coaching simulation scenario.

5. The coaching simulator system of claim 1, wherein the operations further comprise:
determining that the score for the agent is below a predefined minimum score;
querying the LLM, by the framework, to ask the agent to answer the first question again;
receiving a second answer to the first question from the agent;
querying the LLM, by the framework, to analyze the second answer to the first question; and
querying the LLM, by the framework, to provide real-time feedback and a score for the agent based on the analyzed second answer to the first question.

6. The coaching simulator system of claim 1, wherein the operations further comprise:
determining that the score for the agent exceeds a predefined minimum score;
determining that there is a second question in the first coaching simulation scenario;
querying the LLM, by the framework, to present the second question to the agent;
receiving a first answer to the second question from the agent;
querying the LLM, by the framework, to analyze the first answer to the second question; and
querying the LLM, by the framework, to provide real-time feedback and a score for the agent based on the analyzed first answer to the second question.

7. The coaching simulator system of claim 1, wherein the operations further comprise:
determining that the score for the agent exceeds a predefined minimum score;
determining that there are no more questions in the first coaching simulation scenario;
querying the LLM, by the framework, to provide a summary report; and
confirming that the agent wishes to continue to a second coaching simulation scenario.

8. The coaching simulator system of claim 1, wherein the LLM comprises a generative pre-trained transformer (GPT).

9. A method for simulating a coaching session, which comprises:
receiving an interaction between a customer and an agent;
scoring the interaction using an evaluation form;
identifying a recurring improvement area for the agent based on the scored interaction and past scored interactions;
creating a prompt for a large language model (LLM) by populating a prompt template with a definition of the evaluation form, evaluation questions, a simulation objective, and a simulation example, wherein the definition of the evaluation form, the evaluation questions, the simulation objective and the simulation example are based on the recurring improvement area;
providing a framework to invoke the LLM using the created prompt, a model, and a plurality of hyperparameters;
starting a first coaching simulation scenario by invoking the LLM, via the framework, to present a first question to the agent;
receiving a first answer to the first question from the agent;
querying the LLM, via the framework, to analyze the first answer to the first question; and
querying the LLM, via the framework, to provide real-time feedback and a score for the agent based on the analyzed first answer to the first question.

10. The method of claim 9, wherein identifying a recurring improvement area for the agent comprises:
selecting past scored interactions with a score lower than a threshold score; and
identifying a most frequent scenario in the selected past scored interactions.

11. The method of claim 9, wherein the hyperparameters comprise a temperature hyperparameter and a top_p hyperparameter.

12. The method of claim 9, wherein providing a framework to invoke the LLM comprises maintaining a conversational memory of the first coaching simulation scenario.

13. The method of claim 9, which further comprises:
determining that the score for the agent is below a predefined minimum score;
querying the LLM, by the framework, to ask the agent to answer the first question again;
receiving a second answer to the first question from the agent;
querying the LLM, by the framework, to analyze the second answer to the first question; and
querying the LLM, by the framework, to provide real-time feedback and a score for the agent based on the analyzed second answer to the first question.

14. The method of claim 9, which further comprises:
determining that the score for the agent exceeds a predefined minimum score;
determining that there is a second question in the first coaching simulation scenario;
querying the LLM, by the framework, to present the second question to the agent;
receiving a first answer to the second question from the agent;
querying the LLM, by the framework, to analyze the first answer to the second question; and
querying the LLM, by the framework, to provide real-time feedback and a score for the agent based on the analyzed first answer to the second question.

15. The method of claim 9, which further comprises:
determining that the score for the agent exceeds a predefined minimum score;
determining that there are no more questions in the first coaching simulation scenario;
querying the LLM, by the framework, to provide a summary report; and
confirming that the agent wishes to continue to a second coaching simulation scenario.

16. A non-transitory computer-readable medium having stored thereon computer-readable instructions executable by a processor to perform operations which comprise:
receiving an interaction between a customer and an agent;
scoring the interaction using an evaluation form;
identifying a recurring improvement area for the agent based on the scored interaction and past scored interactions;
creating a prompt for a large language model (LLM) by populating a prompt template with a definition of the evaluation form, evaluation questions, a simulation objective, and a simulation example, wherein the definition of the evaluation form, the evaluation questions, the simulation objective and the simulation example are based on the recurring improvement area;
providing a framework to invoke the LLM using the created prompt, a model, and a plurality of hyperparameters;
starting a first coaching simulation scenario by invoking the LLM, via the framework, to present a first question to the agent;
receiving a first answer to the first question from the agent;
querying the LLM, via the framework, to analyze the first answer to the first question; and
querying the LLM, via the framework, to provide real-time feedback and a score for the agent based on the analyzed first answer to the first question.

17. The non-transitory computer-readable medium of claim 16, wherein identifying a recurring improvement area for the agent comprises:
selecting past scored interactions with a score lower than a threshold score; and
identifying a most frequent scenario in the selected past scored interactions.

18. The non-transitory computer-readable medium of claim 16, wherein the operations further comprise:
determining that the score for the agent is below a predefined minimum score;
querying the LLM, by the framework, to ask the agent to answer the first question again;
receiving a second answer to the first question from the agent;
querying the LLM, by the framework, to analyze the second answer to the first question; and
querying the LLM, by the framework, to provide real-time feedback and a score for the agent based on the analyzed second answer to the first question.

19. The non-transitory computer-readable medium of claim 16, wherein the operations further comprise:
determining that the score for the agent exceeds a predefined minimum score;
determining that there is a second question in the first coaching simulation scenario;
querying the LLM, by the framework, to present the second question to the agent;
receiving a first answer to the second question from the agent;
querying the LLM, by the framework, to analyze the first answer to the second question; and
querying the LLM, by the framework, to provide real-time feedback and a score for the agent based on the analyzed first answer to the second question.

20. The non-transitory computer-readable medium of claim 16, wherein the operations further comprise:
determining that the score for the agent exceeds a predefined minimum score;
determining that there are no more questions in the first coaching simulation scenario;
querying the LLM, by the framework, to provide a summary report; and
confirming that the agent wishes to continue to a second coaching simulation scenario.
